(19) United States
(12) Patent Application Publication
(10) Pub. No.: US 2024/0420569 A1
(43) Pub. Date: Dec. 19, 2024

(54) METHOD FOR PROVIDING A DISPLAY OF A TRAFFIC SITUATION

(71) Applicant: CARIAD SE, Wolfsburg (DE)

(72) Inventors: Michael STARK, Wolfsburg (DE); Ferdinand FARENHOLTZ, Wolfsburg (DE)

(21) Appl. No.: 18/747,311

(22) Filed: Jun. 18, 2024

(30) Foreign Application Priority Data
Jun. 19, 2023 (DE) 102023115942.9

(51) Int. Cl. G08G 1/0962; G08G 1/01

(52) U.S. Cl. CPC G08G 1/09626; G08G 1/0112; G08G 1/0133

(57) ABSTRACT

The disclosure relates to a method for providing a display of a traffic situation on a display device of a vehicle, including: acquiring surroundings data in surroundings of the vehicle, selecting a surrounding area for the display of the traffic situation on the display device, determining a maximum number of objects for the display of the traffic situation on the display device on the selected surrounding area, selecting relevant and/or prioritized objects and/or lanes for the display of the traffic situation on the display device on the selected surrounding area based on the maximum number of objects.

### BACKGROUND

### Technical Field

The disclosure relates to a method for providing a display of a traffic situation on a display device of a vehicle, in particular comprising relevant road users. The disclosure further relates to a corresponding computer program product for carrying out a corresponding method. The disclosure further relates to a corresponding control unit for carrying out a corresponding method. The disclosure further relates to a corresponding display device, a corresponding camera device, a corresponding assistance system and a corresponding vehicle, in particular an assisted, automated and/or autonomously driving vehicle, with a corresponding control unit.

### Description of the Related Art

The sensors in a vehicle acquire numerous surroundings data about a traffic situation. A visualization of all sensor data usually turns out to be unstable, often implausible, arbitrary or not always easy to comprehend for the user. Some methods use fused surroundings data obtained from several vehicle sensors to check the plausibility of objects to be displayed. However, in known vehicles, most display devices output uncorrected sensor data.

### BRIEF SUMMARY

The object of the disclosure is therefore to at least partially overcome at least one of the disadvantages described above. In particular, it is the object of the disclosure an improved method for providing a display of a traffic situation on a display device of a vehicle, which preferably enables a clear and easily comprehensible representation or display of a current traffic situation that dynamically adapts to the prevailing conditions in the changing surroundings of the vehicle, which provides an advantageously selected surrounding area for the display, which displays relevant road users in the selected surrounding area, which facilitates user perception, which increases the safety in the operation of the vehicle and which increases user comfort and confidence in the vehicle. A further object of the disclosure is to provide a corresponding computer program product for carrying out a corresponding method. A further object of the disclosure is to provide a corresponding control unit for carrying out a corresponding method. Furthermore, it is the object of the disclosure to provide a corresponding display device, a corresponding camera device, a corresponding assistance system and a corresponding vehicle, in particular an assisted, automated and/or autonomously driving vehicle, with a corresponding control unit.

The disclosure provides a method which was developed specifically for providing a display of a traffic situation on a display device of a vehicle, in particular an assisted, automated and/or autonomously driving vehicle.

The method has the following method steps:
acquiring (for example, through vehicle-side sensing, active querying, passive obtaining, predictive forecasting and/or experience-based estimation) surroundings data in surroundings of the vehicle;
selecting, preferably dynamically selecting, a surrounding area for the display;
determining a, in particular maximum, preferably parameterizable, number of objects for the display on the selected surrounding area; and
selecting, preferably adaptively selecting, in particular relevant and/or prioritized, objects and/or lanes for display on the selected surrounding area depending on the determined number.

The method steps can be carried out in the specified order and/or at least partially overlapping and/or simultaneously. Advantageously, the method steps can be carried out repeatedly in order to enable an improved display of a current traffic situation that dynamically adapts to prevailing conditions in the changing surroundings of the vehicle.

Different road users in a traffic situation can be referred to as objects, for example other vehicles, pedestrians, people, animals, etc.

When selecting objects, in particular relevant and/or prioritized objects, a current number of objects in the area surrounding the vehicle can be determined and can be compared with the determined, in particular maximum, number of objects. If, according to the surroundings data, the current number of objects in the area surrounding the vehicle is smaller than the determined, in particular maximum, number of objects, then all current objects can be displayed. If, according to the surroundings data, the current number of objects in the area surrounding the vehicle is greater than the determined, in particular maximum, number of objects, then relevant and/or prioritized objects can be selected in the next step for display on the selected surrounding area.

The disclosure thus provides a method which enables a clear and easy-to-comprehend display of a current traffic situation on a display device of a vehicle, which dynamically adapts to prevailing conditions in the changing surroundings of the vehicle, which represents a specifically selected surrounding area, which visualizes relevant road users or objects on the selected surrounding area, which facilitates the user's perception of the surroundings of the vehicle and the current traffic situation, which increases the safety in the operation of the vehicle and which increases user comfort and confidence in the display device.

Advantageously, it can be provided that, when acquiring surroundings data, lane data, for example having a number of lanes, a direction of travel on a lane, a lane type, a lane marking, a lane width, a lane orientation and/or a lane course, and/or object data, for example having an object type, an object position, a distance to the vehicle, a relative speed to the vehicle and/or a relative orientation to the vehicle of road users or objects in the surroundings of the vehicle are determined. In this way, different data can be taken into account as part of surroundings data, which can serve to acquire, analyze and image a current traffic situation in an advantageous manner.

Surroundings data can therefore comprise lane data and/or object data. In this way, relevant information about a current traffic situation can be determined in order to analyze the traffic situation and provide an improved display.

The lane data can, for example, have a number of lanes on a road, a direction of travel on at least one lane (for example, one's own lane, at least an adjacent lane, preferably a nearest adjacent lane, etc.), a lane type (for example, a main road, for example in a city, a highway, a straight-ahead lane, a left-turn lane, a right-turn lane, a freeway road, possibly with a corresponding lane arrangement, for example far right, middle, left, etc., a freeway exit, etc.), at least one lane marking (for example, a curb, a dashed line, a solid line, etc.), a lane width (normal lane width, narrowed lane width, for example as a result of a construction site, etc.), a lane orientation (forward, to the left, to the right, or the like), and/or a lane course (for example, straight, curved, etc.).

The object data can, for example, have an object type (such as, for example, people, animal, bicycle, scooter, vehicle type, etc.), a distance to the vehicle, a relative speed to the vehicle, and/or a relative orientation to the vehicle of objects in the surroundings of the vehicle.

On the one hand, it is conceivable that the lane data can be determined from sensor data, preferably camera data, of the vehicle.

In principle, however, it is also conceivable that the lane data can be determined from the map data and/or swarm data of an external device and/or from other road users.

It is also conceivable that the lane data can be obtained using camera data from the own vehicle and/or using map data and/or swarm data from an external device and/or from other road users.

On the other hand, it is conceivable that the object data can be determined from sensor data from at least one sensor, for example a camera, a radar sensor, a lidar sensor and/or an ultrasonic sensor, of the vehicle.

Furthermore, it is conceivable that the object data can be obtained from an external device, an infrastructure device and/or from road users, for example via Car2X communication.

In principle, it can be advantageous if the acquired surroundings data is compared, consolidated and/or checked for plausibility.

Furthermore, it can be provided that selecting the surrounding area for the display is carried out dynamically. In other words, the surrounding area for the display can be dynamically selected and flexibly adapted depending on the situation. In this way, a specifically selected surrounding area can be selected for the display that is relevant to a current traffic situation. Selecting the surrounding area can advantageously be carried out specifically using certain rules or framework conditions.

On the one hand, it is conceivable that, when selecting the surrounding area for the display, lane data, for example having a number of lanes, a direction of travel on a lane, a lane type, a lane marking, a lane width, a lane orientation and/or a lane course, and/or object data, for example, comprising an object type, an object position, a distance to the vehicle, a relative speed to the vehicle and/or a relative orientation to the vehicle of objects in the area surrounding the vehicle can be taken into account. In this way it can be made possible for the surrounding area for the display to preferably only be able to visualize relevant lanes and/or only relevant objects.

Advantageously, it can be provided that, when selecting the surrounding area for the display, at least one distance from the vehicle in at least one direction with respect to the vehicle, is taken into account, preferably dynamically. In this way, a representative surrounding area can be selected, which can be easily determined with respect to the vehicle and set with little computational effort.

In order to be able to represent a traffic situation in a comprehensible manner, it can be provided that the at least one distance comprises a (so-called first) distance x, for example comprising a minimum distance and/or a maximum distance, in a direction of travel, and/or a (so-called second) distance y, for example one lane on the left and one lane on the right or two lanes on the left and two lanes on the right, provided that the left lanes are relevant, in a vehicle transverse direction. In this way, the relevant surrounding area can be imaged in a manageable manner.

Furthermore, it can be provided that the at least one distance, in particular a distance in a direction of travel, is determined depending on at least one operating parameter of the vehicle, for example comprising a speed of the vehicle and/or an acquisition range and/or visibility range of at least one sensor of the vehicle. A speed of the vehicle can be characteristic of a certain driving situation. In a driving situation on a freeway, it is conceivable, in principle, that a larger surrounding area can be displayed than in the city because the vehicle is supposed to look further ahead than in a city. If the acquisition range and/or visibility range of the vehicle sensor system is reduced, for example when a curve is ahead and/or when visibility is obscured and/or when weather conditions affect visibility, it can in turn be advantageous to display an extended surrounding area in order to compensate for the reduced visibility range.

Furthermore, it can be provided that the at least one distance, in particular a (first) distance x in a direction of travel, is determined depending on at least one navigation parameter, for example comprising a planned route, a direction of travel and/or an expected turning direction. In this way, the surrounding area for the display can even be selected in a predictive manner in order to display relevant information for the vehicle's planned travel.

In addition, it can be provided that the at least one distance, in particular a (second) distance y in a vehicle transverse direction, is determined depending on at least one traffic parameter, for example comprising a number of lanes, a direction of travel on a lane, a lane type, a lane marking, a lane width, a lane orientation, a road course and/or a traffic density. In this way, the surrounding area for the display can be selected depending on the traffic. On a multi-lane freeway, not all lanes need to be displayed in order to enable a comprehensible display of a traffic situation. In this case, it can be advantageous to display only one or two adjacent (or another specific number of adjacent) lanes. In the case of an adjacent lane that, for example, leads in a different direction and/or that does not allow a change to one's own lane, it can be advantageous for the clarity of the display to exclude this lane from the surrounding area for the display. In this way, the display can be made manageable and comprehensible.

But also other operating parameters of the vehicle, such as, for example, a state of a direction indicator, can impact the driving situation and be taken into account when selecting the surrounding area in a vehicle transverse direction for the display. If, for example, a turn signal is activated, it can generally be advantageous to display the lane within the surrounding area into which changing is to take place.

In principle, it is also conceivable that the at least one distance can be determined depending on at least one environmental parameter, for example comprising weather conditions, lighting conditions, ambient humidity and/or road conditions. In this way, poor visibility can be compensated for in an advantageous way. Furthermore, a current traffic situation and/or driving situation of the vehicle can be analyzed more accurately.

In order to enable a dynamic display of relevant road users in the selected surrounding area, it may be advantageous for the determination of the, in particular maximum, number of objects for the display on the selected surrounding area to be carried out in a parameterized manner. In other words, it can be advantageous if the number of objects on the selected surrounding area is parameterized or made dependent on parameters. In this way, the maximum number of objects to be displayed can be set flexibly in order to be able to react specifically to changing driving situations.

In principle, it is possible that when determining the, in particular maximum, number of objects for display on the selected surrounding area, lane data, for example having a number of lanes, a direction of travel on a lane, a lane type, a lane marking, a lane width, a lane orientation and/or a lane course, and/or object data, for example comprising an object type, an object position, a distance to the vehicle, a relative speed to the vehicle and/or a relative orientation to the vehicle of objects in the surrounding area of the vehicle, can be taken into account. In this way, an appropriate number of objects to be displayed can be determined for different surroundings data.

Advantageously, when determining the, in particular maximum, number of objects for display on the selected surrounding area, a current driving situation (or scenario), for example comprising at least one piece of information about a road type (freeway, highway, city street, etc.), a traffic density, a speed limit, sign information and/or a traffic light position, can be taken into account. Depending on the driving situation, it may be advantageous to display more or fewer objects in order to ensure safe driving, to enable a comprehensible display and to avoid overwhelming the user. When driving on a freeway, more objects, such as, for example, vehicles in front of the own vehicle and/or vehicles in the adjacent lanes, can principally be displayed than in a city in order not to overwhelm the user with information and not to cover the display.

It may also be advantageous if, when determining the, in particular maximum, number of objects for the display on the selected surrounding area, active driver assistance systems, for example assistance systems for assisted or autonomous driving, assistance systems for assisted or autonomous keeping a distance from a vehicle in front, assistance systems for assisted or autonomous lane keeping, assistance systems for assisted or autonomous overtaking, assistance systems for monitoring a blind spot, assistance systems for assisted or autonomous turning and/or assistance systems for assisted or autonomous parking, of the vehicle can be taken into account. When the ACC assistance system is activated, it can be useful, for example, to display a vehicle driving ahead and, if applicable, vehicles in the adjacent lanes that may cut in in front of the own vehicle. When turning, it can be advantageous to display more vehicles in the lane into which turning is to take place.

In principle, it is also conceivable that when determining the, in particular maximum, number of objects for display on the selected surrounding area, at least one operating parameter of the vehicle, for example comprising a speed of the vehicle and/or a state of a direction indicator, can be taken into account. The faster the vehicle is driving, the more objects or road users can be relevant for a current driving situation. The state of a turn signal can also be relevant in order to be able to display the turning situation with relevant road users in detail.

In principle, it is also conceivable that, when determining the, in particular maximum, number of objects for display on the selected surrounding area, at least one navigation parameter, for example comprising a planned route, a direction of travel and/or an expected turning direction, can be taken into account. In this way, driving situations can be forecast in a predictive manner and the maximum number of objects can be flexibly adapted to the situation.

Furthermore, when determining the, in particular maximum, number of objects for display on the selected surrounding area, at least one traffic parameter, for example comprising a number of lanes, a direction of travel on a lane, a lane type, a lane marking, a lane width, a lane orientation, a road course and/or traffic density, can be taken into account. For example, on a freeway with three lanes, it can be provided that a total of three vehicles are displayed, displaying one vehicle per lane, for example.

In principle, it is possible that, when determining the, in particular maximum, number of objects for display on the selected surrounding area, at least one environmental parameter, for example comprising weather conditions, lighting conditions, ambient humidity and/or road conditions, can be taken into account. The more difficult the weather conditions, for example the worse the lighting conditions, the more objects can be relevant for the safe operation of the vehicle.

Advantageously, selecting of, in particular, relevant and/or prioritized objects and/or lanes for the display on the selected surrounding area can be carried out adaptively. In this way, the relevant road users can be selected flexibly, depending on the situation, customer-specific or the like. This allows a current traffic situation to be flexibly mapped in an improved manner.

In particular, selecting, in particular, relevant and/or prioritized objects and/or lanes for the display on the selected surrounding area can be carried out using a prioritization function and/or a characteristic diagram. In this way, an automatic, computationally simple and reliable prioritization of relevant road users for the display can be provided.

Advantageously, it can be provided that, when selecting, in particular relevant and/or prioritized, objects and/or lanes for the display on the selected surrounding area, lane data, for example having a number of lanes, a direction of travel on a lane, a lane type, a lane marking, a lane width, a lane orientation and/or a lane course, and/or object data, for example comprising an object type, an object position, a distance to the vehicle, a relative speed to the vehicle and/or a relative orientation to the vehicle of objects in the surroundings of the vehicle, are taken into account. Certain lanes, for example into which a turn is made, and/or certain objects, for example pedestrians and/or cyclists, can be given higher priority than lanes further away and/or heavy motor vehicles. In this way, an advantageous prioritization of information that the display can provide, can be carried out.

In order to increase the safety during operation of the vehicle and to enable improved display, it can be provided that, when selecting, in particular relevant and/or prioritized, objects and/or lanes for display on the selected surrounding area, a probability of interaction with the vehicle is taken into account.

In order to increase the safety during operation of the vehicle and to enable an improved display, it can further be provided that when selecting, in particular relevant and/or prioritized, objects and/or lanes for display on the selected surrounding area, a relevance for operation, for example manual, automated or autonomous operation, and/or for guidance or control, for example longitudinal and/or transverse guidance, of the vehicle is taken into account.

Furthermore, when selecting, particularly relevant and/or prioritized, objects and/or lanes, for display on the selected surrounding area, a current driving situation (or scenario), for example comprising at least one piece of information about a type of road (freeway, highway, city street, etc.), a traffic density, a speed limit, sign information and/or a traffic light position, can be taken into account. In this way, the relevant information for the representation of a current traffic situation can be checked for plausibility in an advantageous manner.

Furthermore, when selecting, in particular relevant and/or prioritized objects and/or lanes, for the display on the selected surrounding area, active driver assistance systems, for example assistance systems for assisted, automated or autonomous driving, assistance systems for assisted, automated or autonomous keeping a distance from a vehicle in front, assistance systems for assisted, automated or autonomous lane keeping, assistance systems for assisted, automated or autonomous overtaking, assistance systems for assisted, automated or autonomous monitoring of a blind spot, assistance systems for assisted, automated or autonomous turning and/or assistance systems for parking, of the vehicle, can be taken into account. Being aware of active driver assistance systems, the relevant information for displaying a current traffic situation can be specifically selected.

In addition, when selecting, in particular relevant and/or prioritized, objects and/or lanes, for the display on the selected surrounding area, at least one operating parameter of the vehicle, for example comprising a speed of the vehicle and/or a state of a direction indicator, can be taken into account. In this way, the relevant information for the representation of a current traffic situation can be further checked for plausibility.

In addition, when selecting, in particular relevant and/or prioritized, objects for the display on the selected surrounding area, at least one navigation parameter, for example comprising a planned route, a direction of travel and/or an expected turning direction, can be taken into account. In this way, the relevant information for the representation of a current traffic situation can be determined in a predictive manner.

In addition, when selecting, in particular relevant and/or prioritized, objects and/or lanes for the display on the selected surrounding area, at least one traffic parameter, for example comprising a number of lanes, a direction of travel on a lane, a lane type, a lane marking, a lane width, a lane orientation, a road course and/or traffic density, can be taken into account. In this way, the relevant information for the representation of a current traffic situation can be further checked for plausibility.

In principle, it is conceivable that, when selecting, in particular relevant and/or prioritized, objects and/or lanes for the display on the selected surrounding area, at least one environmental parameter, for example comprising weather conditions, lighting conditions, ambient humidity and/or road conditions, can be taken into account. In this way, the relevant information for the representation of a current traffic situation can be further checked for plausibility.

Furthermore, the method can provide:
providing the display on the selected surrounding area, on which selected, in particular relevant and/or prioritized, objects and/or lanes are visualized.

An improved display in the sense of the present disclosure can thus be provided.

Advantageously, the method steps can be carried out repeatedly in order to enable a dynamic display for a changing traffic situation in the surroundings of the vehicle.

Furthermore, the disclosure provides a computer program product comprising commands which, when the computer program product is executed by a computer, cause the computer to carry out a method which can be executed as described above. Using the computer program product, the same advantages can be achieved that were described above in connection with the method according to the disclosure. Reference is made to these advantages herein in their entirety.

Furthermore, the disclosure provides a control unit, having a computing unit and a memory unit in which code is stored which, when at least partially executed by the computing unit, carries out a method which can be executed as described above. Using the control unit, the same advantages can be achieved that were described above in connection with the method according to the disclosure. Reference is made to these advantages herein in their entirety.

In addition, the disclosure provides a display device for a vehicle, having a control unit that can be embodied as described above. Using the display device, the same advantages can be achieved that were described above in connection with the method according to the disclosure. Reference is made to these advantages herein in their entirety.

A display device can be designed, for example, in the form of a display, a head-up display, a hologram, a virtual display, for example on a vehicle window, or the like.

In addition, the disclosure provides a camera device for a vehicle, having a control unit that can be embodied as described above. Using the camera device, the same advantages can be achieved that were described above in connection with the method according to the disclosure. Reference is made to these advantages herein in their entirety.

In addition, the disclosure provides an assistance system for a vehicle, having a control unit that can be embodied as described above. Using the assistance system, the same advantages can be achieved that were described above in connection with the method according to the disclosure. Reference is made to these advantages herein in their entirety.

Furthermore, the disclosure provides a vehicle, having a control unit that can be embodied as described above. Using the vehicle, the same advantages can be achieved that were described above in connection with the method according to the disclosure. Reference is made to these advantages herein in their entirety.

### BRIEF DESCRIPTION OF THE SEVERAL VIEWS OF THE DRAWINGS

Further advantages, features and details of the disclosure emerge from the following description, in which several exemplary embodiments of the disclosure are described in detail with reference to the drawings.

FIG. 1 shows a schematic representation of a sequence of a method within the meaning of the present disclosure;

FIG. 2 shows a schematic representation of a selected surrounding area;

FIG. 3 shows a schematic representation of a selected surrounding area and relevant objects according to a prioritization function; and

FIG. 4 shows a schematic representation of a selected surrounding area and relevant objects according to an adaptively adapted prioritization function.

### DETAILED DESCRIPTION

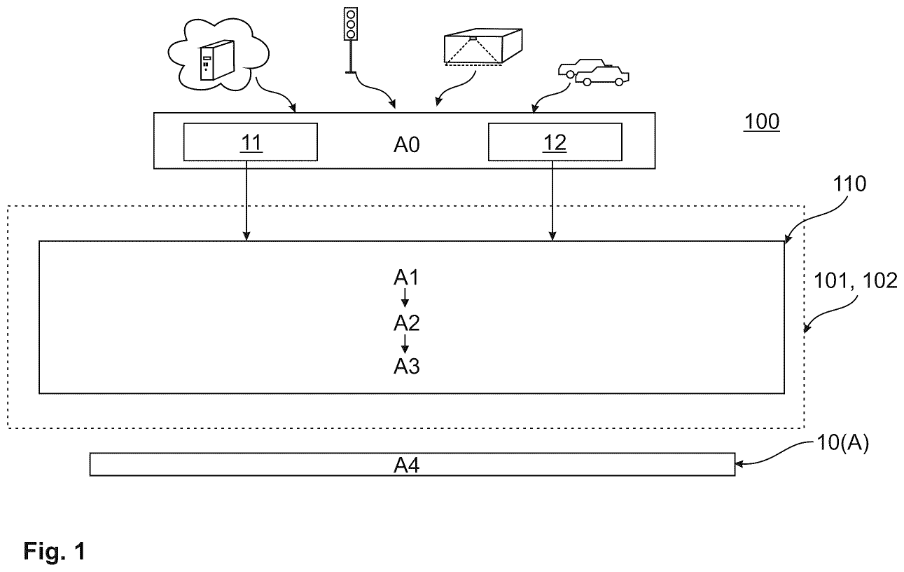

FIGS. 1 to 4 serve to explain a method within the meaning of the disclosure, which was developed for providing a display A or a representation of a traffic situation on a display device 10 of a vehicle 100, in particular an assisted, automated and/or autonomously driving vehicle.

As indicated in FIG. 1, the method has the following method steps:
acquiring A0 (for example, by vehicle-side sensing, active querying, passive obtaining, predictive forecasting and/or experience-based estimation) of surroundings data 11, 12 in surroundings U of vehicle 100;
selecting A1, preferably dynamically selecting, a surrounding area B for the display A;
determining A2 a, in particular maximum, preferably parameterizable, number N of objects O for the display A on the selected surrounding area B; and
selecting A3, preferably adaptively selecting, in particular relevant and/or prioritized, objects O and/or lanes S for the display A on the selected surrounding area B depending on the determined number N.

As further indicated in FIG. 1, the method can provide for:
providing A4 the display A on the selected surrounding area B, on which selected, in particular relevant and/or prioritized, objects O and/or lanes S are visualized.

Method steps A0 to A3 or A4 can be carried out repeatedly in order to enable a dynamic display A for a changing traffic situation in the surroundings U of vehicle 100.

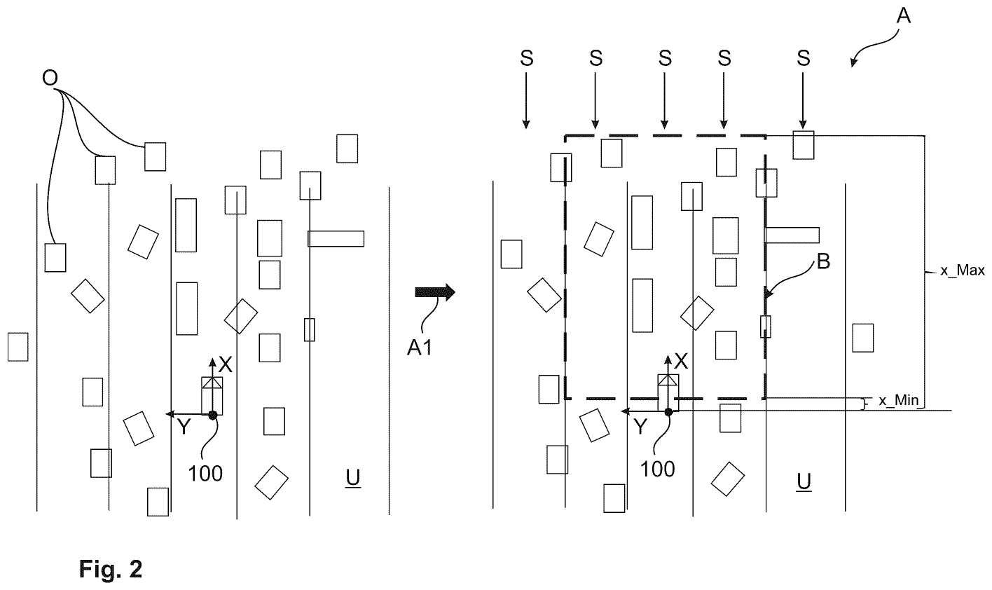

Objects O can comprise different participants in a traffic situation, for example other vehicles, pedestrians, people, animals, etc. FIGS. 2 to 4 show vehicles as objects O merely as examples.

When selecting, in particular relevant and/or prioritized objects O, a current number of objects in the surroundings U of vehicle 100 can be determined and compared with the determined, in particular maximum, number N of objects O.

If, according to surroundings data 11, 12, the current number of objects O in surroundings U of vehicle 100 is smaller than the determined, in particular maximum, number N of objects O, then all current objects can be displayed.

As indicated in FIGS. 2 to 4 for the case when, according to surroundings data 11, 12, the current number of objects O in surroundings U of vehicle 100 is greater than the determined, in particular maximum, number N of objects O, then, in step A3, relevant and/or prioritized objects O can be selected for display A on selected surrounding area B.

The method enables a clear and easily comprehensible display A of a current traffic situation on a display device 10 of vehicle 100, which can dynamically adapt to prevailing conditions in changing surroundings U of vehicle 100, which can display a specifically selected surrounding area B, which can visualize relevant objects O on selected surrounding area B, which can facilitate the user's perception of surroundings U of vehicle 100 and the current traffic situation, which can increase the safety in the operation of vehicle 100 and which can increase user comfort and confidence in the method.

As indicated in FIG. 1, lane data 11 and/or object data 12 can be determined when surroundings data 11, 12 are acquired.

Surroundings data 11, 12 can be used to determine a current number of objects O in surroundings U of vehicle 100.

However, surroundings data 11, 12 can also comprise much more relevant information about a current traffic situation, which can be used to analyze the traffic situation and provide an improved display A.

Lane data 11 can, for example, have a number of lanes on a road, a direction of travel on at least one lane (for example, one's own lane, at least an adjacent lane, preferably a nearest adjacent lane, etc.), a lane type (for example, a main road, for example in a city, a highway, a straight-ahead lane, a left-turn lane, a right-turn lane, a freeway road, possibly with a corresponding lane arrangement, for example far right, middle, left, etc., a freeway exit, etc.), at least one lane marking (for example, a curb, a dashed line, a solid line, etc.), a lane width (normal lane width, narrowed lane width, for example as a result of a construction site, etc.), a lane orientation (forward, to the left, to the right, or the like), and/or a lane course (for example, straight, curved, etc.).

Object data 12 can, for example, have an object type (such as, for example, people, animal, bicycle, scooter, vehicle type, or the like), a distance to vehicle 100, a relative speed to vehicle 100, and/or a relative orientation to vehicle 100, of objects O in the surroundings of vehicle 100.

Lane data 11 can be obtained from sensor data, preferably camera data, of vehicle 100.

As indicated by FIG. 1, lane data 11 can also be determined from the map data and/or swarm data from an external device 200 and/or from other road users.

Lane data 11 can be checked for plausibility using camera data from own vehicle 100 and/or using map data and/or swarm data from an external device 200 and/or from other road users.

Object data 12 can also be determined from sensor data from at least one sensor, for example a camera, a radar sensor, a lidar sensor and/or an ultrasonic sensor, of vehicle 100.

As indicated by FIG. 1, object data 12 can also be obtained from an external device 200, an infrastructure device and/or from road users, for example via Car2X communication.

Advantageously, acquired surroundings data 11, 12 can be compared, checked for plausibility and/or consolidated.

Selecting surrounding area B for display A can preferably be carried out dynamically.

When selecting surrounding area B for display A, lane data 11 and/or object data 12 can be taken into account.

As indicated by FIGS. 2 to 4, when selecting surrounding area B for display A, at least one distance x, y to vehicle 100 in at least one direction x, y with respect to vehicle 100 can be taken into account, preferably dynamically.

As indicated by FIGS. 2 to 4, for example, the at least one distance x, y can comprise a distance x, for example comprising a minimum distance x_Min and/or a maximum distance x_Max, in a direction of travel X, and/or a distance y, for example one lane to the left and one lane to the right or two lanes to the left and two lanes to the right, in a vehicle transverse direction Y.

The distance x in a direction of travel X can also be determined depending on at least one operating parameter BP of vehicle 100, for example comprising a speed V of vehicle 100 and/or an acquisition range and/or visibility range of at least one sensor of vehicle 100. On a freeway, a larger surrounding area B can be displayed than in the city. With a reduced acquisition range and/or visibility range of the vehicle sensor system, an expanded surrounding area can in turn be displayed in order to compensate for the reduced acquisition range and/or visibility range.

The distance x in a direction of travel X can also be determined depending on at least one navigation parameter NP, for example comprising a planned route, a direction of travel and/or an expected turning direction. In this way, surrounding area B for display A can be selected in a predictive manner in order to be able to react early to changing traffic situations.

As indicated by FIGS. 2 to 4, a distance y in a vehicle transverse direction Y can be determined, for example, depending on at least one traffic parameter VP, for example comprising a number of lanes, a direction of travel on a lane, a lane type, a lane marking, a lane width, a lane orientation, a road course and/or a traffic density. On a multi-lane freeway, not all lanes S need to be displayed in order to enable a comprehensible display A of a traffic situation. In this case, it may, for example, be sufficient to display only one or two adjacent lanes. An adjacent lane S, which for example leads in a different direction and/or which does not allow a change to one's own lane S, can be excluded from surrounding area B for display A for the sake of simplicity.

The at least one distance x, y can also be determined depending on at least one environmental parameter UP, for example comprising weather conditions, lighting conditions, ambient humidity and/or road conditions.

Determining A2 the, in particular maximum, number N of objects O for display A on selected surrounding area B can preferably be carried out in a parameterized manner.

When determining A2, in particular maximum, number N of objects O for display A in selected surrounding area B, for example, lane data 11 and/or object data 12 can be taken into account.

When determining A2, in particular maximum, number N of objects O for display A on selected surrounding area B, a current driving situation (or scenario), for example comprising at least one piece of information about a road type (freeway, highway, city street, etc.), a traffic density, a speed limit, sign information and/or a traffic light position, can also be taken into account. In this way, an adaptive number N of objects O can be displayed depending on the driving situation.

When determining A2, in particular maximum, number N of objects O for display A on selected surrounding area B, active driver assistance systems, for example assistance systems for assisted or autonomous driving, assistance systems for assisted or autonomous keeping a distance from a vehicle in front, assistance systems for assisted or autonomous lane keeping, assistance systems for assisted or autonomous overtaking, assistance systems for monitoring a blind spot, assistance systems for assisted or autonomous turning and/or assistance systems for assisted or autonomous parking, of vehicle 100 can also be taken into account. With an active ACC system, it can be advantageous for a comprehensible display A to display a vehicle driving ahead, as well as any vehicles in the adjacent lanes that can generally cut in ahead of one's own vehicle. In a turning maneuver, it can be advantageous to display more vehicles in the lane into which turning is to take place.

When determining A2, in particular maximum, number N of objects O for display A in selected surrounding area B, at least one operating parameter BP of vehicle 100, for example comprising a speed V of vehicle 100 and/or a state of a direction indicator, can also be taken into account.

When determining A2, in particular maximum, number N of objects O for display A in selected surrounding area B, furthermore at least one navigation parameter NP, for example comprising a planned route, a direction of travel and/or an expected turning direction, can be taken into account.

When determining A2, in particular maximum, number N of objects O for display A in selected surrounding area B, at least one traffic parameter VP, for example comprising a number of lanes, a direction of travel on a lane, a lane type, a lane marking, a lane width, a lane orientation, a road course and/or a traffic density, can also be taken into account.

In principle, it is possible that, when determining A2, in particular maximum, number N of objects O for display A in selected surrounding area B, at least one environmental parameter UP, for example comprising weather conditions, lighting conditions, ambient humidity and/or road conditions, can be taken into account.

In this way, display A can be more or less detailed, depending on the current driving situation, what the traffic looks like and/or what the weather conditions are.

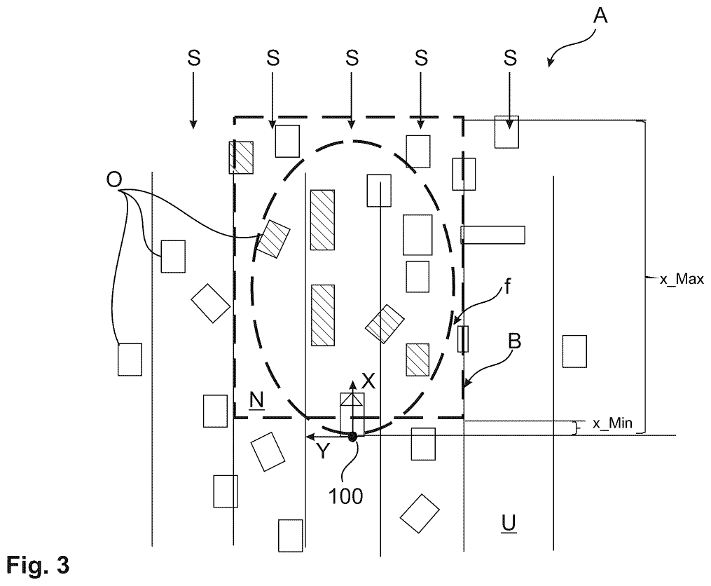

As indicated by FIG. 3, selecting A3, in particular relevant and/or prioritized, objects O and/or lanes S for display A in selected surrounding area B can be carried out adaptively.

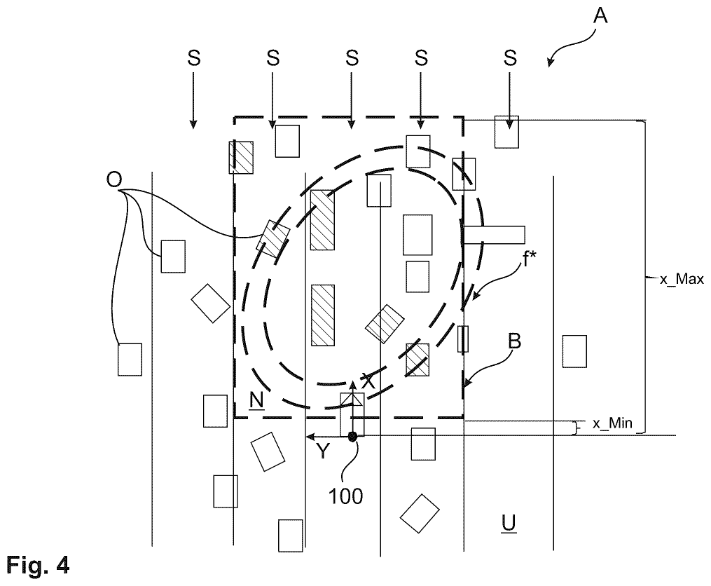

As indicated by FIG. 3 in comparison to FIG. 4, selecting A3, in particular, relevant and/or prioritized objects O and/or lanes S for display A in selected surrounding area B can be carried out using a, likewise adaptive, prioritization function f and/or an adaptive characteristic diagram. In this way, an automatic, computationally simple and reliable prioritization of relevant road users for the display can be provided.

In FIG. 3, prioritization function f can be determined, for example, as follows:

f=f(x,y).

In FIG. 3, prioritization function f* can be determined, for example, as follows:

f*=f_{adapt}(x,y) or f*=f(x_{adapt},y_{adapt}) or the like.

When selecting A3, in particular, relevant and/or prioritized objects O and/or lanes S for display A in selected surrounding area B, lane data 11 and/or object data 12 can also be taken into account.

In order to increase the safety during operation of vehicle 100 and to enable improved display A, when selecting A3, in particular relevant and/or prioritized, objects O and/or lanes S for display A on selected surrounding area B, a probability of interaction with vehicle 100 can be taken into account.

In order to further increase safety during operation of the vehicle and to enable an improved display, when selecting A3, in particular relevant and/or prioritized, objects O and/or lanes S for display A on selected surrounding area B, a relevance for an operation, for example a manual, automated or autonomous operation, and/or for a guidance or control, for example a longitudinal and/or transverse guidance, of vehicle 100 can be taken into account.

When selecting A3, in particular relevant and/or prioritized objects O and/or lanes S for display A in selected surrounding area B, however, a current driving situation (or scenario), for example comprising at least one piece of information about a road type (freeway, highway, city street, etc.), traffic density, speed limit, sign information and/or traffic light position, can also be taken into account.

When selecting A3, in particular relevant and/or prioritized objects O and/or lanes S for display A in selected surrounding area B, active driver assistance systems, for example assistance systems for assisted, automated or autonomous driving, assistance systems for assisted, automated or autonomous keeping a distance from a vehicle in front, assistance systems for assisted, automated or autonomous lane keeping, assistance systems for assisted, automated or autonomous overtaking, assistance systems for assisted, automated or autonomous monitoring of a blind spot, assistance systems for assisted, automated or autonomous turning and/or assistance systems for parking, of vehicle 100 can also be taking into account.

When selecting A3, in particular relevant and/or prioritized, objects O and/or lanes S for display A on selected surrounding area B, at least one operating parameter BP of vehicle 100, for example comprising a speed V of vehicle 100 and/or a state of a direction indicator, can be taken into account.

When selecting A3, in particular relevant and/or prioritized, objects O for display A on selected surrounding area B, at least one navigation parameter NP, for example comprising a planned route, a direction of travel and/or an expected turning direction, can also be taken into account.

Even when selecting A3, in particular relevant and/or prioritized, objects O and/or lanes S for display A on selected surrounding area B, at least one traffic parameter VP, for example comprising a number of lanes, a direction of travel on a lane, a lane type, a lane marking, a lane width, a lane orientation, a road course and/or traffic density can be taken into account.

Furthermore, when selecting A3, in particular relevant and/or prioritized, objects O and/or lanes S for display A on selected surrounding area B, at least one environmental parameter UP, for example comprising weather conditions, lighting conditions, ambient humidity and/or road conditions, can be taken into account.

A corresponding computer program product and a corresponding control unit 110 for carrying out a corresponding method also each represent an aspect of the disclosure. Control unit 110 is merely shown schematically in FIG. 1.

A corresponding display device 10, a corresponding camera device 101, a corresponding assistance system 102 and a corresponding vehicle 100 with a corresponding control unit 110 also each represent an aspect of the disclosure and are also merely shown schematically in FIG. 1.

The above explanation of the embodiments describes the present disclosure solely in terms of examples. Of course, individual features of the embodiments can, if technically sensible, be freely combined with one another without departing from the scope of the present disclosure.

German patent application no. 102023115942.9, filed Jun. 19, 2023, to which this application claims priority, is hereby incorporated herein by reference, in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for providing a display of a traffic situation on a display device of an assisted, automated and/or autonomously driving vehicle, the method comprising:
acquiring surroundings data in surroundings of the vehicle;
selecting a surrounding area for the display of the traffic situation on the display device;
determining a maximum number of objects for the display of the traffic situation on the display device on the surrounding area; and
selecting relevant and/or prioritized objects and/or lanes for the display of the traffic situation on the display device on the surrounding area based on the maximum number of objects.

2. The method according to claim 1, wherein the selecting the surrounding area includes dynamically selecting the surrounding area.

3. The method according to claim 1, wherein the selecting the relevant and/or prioritized objects and/or lanes includes dynamically selecting the relevant and/or prioritized objects and/or lanes.

4. The method according to claim 1,
wherein the acquiring surroundings data includes determining lane data including a number of lanes, a direction of travel on a lane, a lane type, a lane marking, a lane width, a lane orientation and/or a lane course, and/or object data including an object type, an object position, a distance to the vehicle, a relative speed to the vehicle and/or a relative orientation to the vehicle.

5. The method according to claim 1,
wherein the selecting the surrounding area takes into account lane data and/or object data in the surroundings of the vehicle.

6. The method according to claim 1,
wherein the selecting the surrounding area takes into account at least one distance to the vehicle in at least one direction with respect to the vehicle.

7. The method according to claim 6,
wherein the at least one distance includes a first distance in a direction of travel determined based on at least one operating parameter of the vehicle including a speed of the vehicle and/or an acquisition range and/or visibility range of at least one sensor of the vehicle, and/or
wherein the at least one distance includes a second distance in the direction of travel determined based on at least one navigation parameter including a planned route, the direction of travel and/or an expected turning direction.

8. The method according to claim 6,
wherein the at least one distance includes a distance in a vehicle transverse direction determined based on at least one traffic parameter including a number of lanes, a direction of travel on a lane, a lane type, a lane marking, a lane width, a lane orientation, a road course and/or traffic density.

9. The method according to claim 1,
wherein the determining the maximum number of objects is carried out in a parameterized manner, and/or
wherein the determining the maximum number of objects is parameterized.

10. The method according to claim 1,
wherein the determining the maximum number of objects takes into account lane data and/or object data.

11. The method according to claim 1,
wherein the determining the maximum number of objects takes into account at least one operating parameter of the vehicle including a speed of the vehicle and/or a state of a direction indicator, and/or
wherein the determining the maximum number of objects takes into account at least one navigation parameter including a planned route, a direction of travel and/or an expected turning direction.

12. The method according to claim 1,
wherein the selecting the relevant and/or prioritized objects and/or lanes is carried out adaptively, and/or
wherein the selecting the relevant and/or prioritized objects is carried out using a prioritization function and/or a characteristic diagram.

13. The method according to claim 1,
wherein the selecting the relevant and/or prioritized objects and/or lanes takes into account one or more active driving assistance systems including assistance systems for assisted, automated or autonomous driving, assistance systems for assisted, automated or autonomous keeping a distance from a vehicle in front, assistance systems for assisted, automated or autonomous lane keeping, assistance systems for assisted, automated or autonomous overtaking, assistance systems for assisted, automated or autonomous monitoring of a blind spot, assistance systems for assisted, automated or autonomous turning and/or assistance systems for parking the vehicle.

14. The method according to claim 1, further comprising:
providing the display of the traffic situation on the display device on the surrounding area on which the relevant and/or prioritized objects and/or lanes are visualized,
wherein the providing includes displaying a changing traffic situation in the surroundings of the vehicle.

15. A non-transitory computer-readable medium storing instructions which, when executed by a computer, cause the computer to carry out the method according to claim 1.

16. A control unit, comprising:
a processor; and
a memory storing instructions which, when executed by the processor, causes the control unit to carry out the method according to claim 1.

17. A display device for a vehicle, the display device comprising:
the control unit according to claim 16.

18. A vehicle, the display device comprising:
the control unit according to claim 17.
